(19) United States
(12) Patent Application Publication
(10) Pub. No.: US 2015/0326373 A1
(43) Pub. Date: Nov. 12, 2015

(54) APPARATUS AND METHOD FOR AVOIDING INTERFERENCE IN DEVICE-TO-DEVICE WIRELESS COMMUNICATION SYSTEM

(71) Applicant: Samsung Electronics Co., Ltd., Suwon-si (KR)

(72) Inventors: Hyunseok RYU, Yongin-si (KR); Seunghoon PARK, Seoul (KR); Jeongho PARK, Seoul (KR); Hyunkyu YU, Suwon-si (KR); Sangwon CHOI, Suwon-si (KR)

(21) Appl. No.: 14/707,628

(22) Filed: May 8, 2015

(30) Foreign Application Priority Data
May 9, 2014 (KR) 10-2014-0055900

(51) Int. Cl. H04L 5/00; H04W 24/02; H04W 72/04

(52) U.S. Cl. CPC H04L 5/0073; H04W 72/042; H04W 24/02; H04W 72/0446; H04W 72/082

(57) ABSTRACT

The present disclosure relates to a pre-5th-Generation (5G) or 5G communication system to be provided for supporting higher data rates beyond 4th-Generation (4G) communication system such as Long Term Evolution (LTE). An apparatus and method for avoiding interference in a wireless communication system, especially in a Device-to-Device (D2D) wireless communication system, are provided. The method includes creating system information including reception resource pool information to be used for the D2D wireless communication in a single radio frame, resource block information for the D2D wireless communication, and Physical Uplink Control Channel (PUCCH) information to be used for a cellular communication, and broadcasting the created system information to devices for performing the cellular communication and the D2D wireless communication.

### CROSS-REFERENCE TO RELATED APPLICATION(S)

This application claims the benefit under 35 U.S.C. §119(a) of a Korean patent application filed on May 9, 2014, in the Korean Intellectual Property Office and assigned Serial number 10-2014-0055900, the entire disclosure of which is hereby incorporated by reference.

### TECHNICAL FIELD

The present disclosure relates to an apparatus and method for avoiding interference in a wireless communication system. More particularly, the present disclosure relates to a Device-to-Device (D2D) wireless communication system.

### BACKGROUND

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

In the 5G system, Hybrid FSK and QAM Modulation (FQAM) and sliding window superposition coding (SWSC) as an advanced coding modulation (ACM), and filter bank multi carrier(FBMC), non-orthogonal multiple access(NOMA), and sparse code multiple access (SCMA) as an advanced access technology have been developed.

Recently, data traffic has rapidly increased in wireless communication networks due to the popularization of smart phones which can provide various types of applications. Additionally, the number of smart phone users may continue to rapidly increase and also a great variety of services such as a Social Network Service (SNS), games, or the like may be activated more and more often. Therefore, data traffic required for smart phones will probably also further increase even more. This increasing trend of data traffic is not merely limited to smart phones but also applies to all devices associated with wireless communication services. Particularly, beyond a communication between persons, a person-to-machine communication or a machine-to-machine communication may further lead to explosive growth of traffic transmitted to base stations.

Accordingly, a solution to the increase of traffic is now required in the wireless communication system. One remarkable solution is a direct communication between devices. This technology, also referred to as Device-to-Device (D2D) communication, is attracting attention both in licensed frequency bands of mobile communication and in license-exempt frequency bands such as a wireless Local Area Network (LAN).

In case a D2D type wireless communication is used on the condition that a cellular type wireless communication exists, interference between resources, e.g., inter-carrier interference (ICI), used in both types may arise.

Additionally, a D2D type wireless device may use the maximum transmission power in order to increase a D2D discovery signal and the coverage (or range) of D2D direct communication. In this case, if a D2D device and an existing cellular device use frequency-divided resources in a same subframe, a signal transmitted for a discovery and/or a communication by the D2D device may cause In-Band Emission (IBE) with a channel transmitted to the base station from the existing cellular device.

Further, if a D2D device and an existing cellular device use time-divided resources in the same frequency band, a signal transmitted for a discovery and/or a communication by the D2D device may cause Inter-Symbol Interference (ISI) with a channel transmitted to the base station from the existing cellular device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for solving an Inter-Carrier Interference (ICI) issue in case of using a Device-to-Device (D2D) type wireless communication in a cellular type wireless communication system.

Another aspect of the present disclosure is to provide an apparatus and method for solving an In-Band Emission (IBE) issue in case of using a D2D type wireless communication in a cellular type wireless communication system.

Another aspect of the present disclosure is to provide an apparatus and method for solving an Inter-Symbol Interference (ISI) issue in case of using a D2D type wireless communication in a cellular type wireless communication system.

In accordance with an aspect of the present disclosure, a method for allocating a resource at a base station of a wireless communication system which supports a D2D wireless communication is provided. The method includes creating system information including reception resource pool information to be used for the D2D wireless communication in a single radio frame, resource block information for the D2D wireless communication, and Physical Uplink Control Channel (PUCCH) information to be used for a cellular communication and broadcasting the created system information to devices for performing the cellular communication and the D2D wireless communication.

In accordance with another aspect of the present disclosure, a base station apparatus for allocating a resource in a wireless communication system which supports a D2D wireless communication is provided. The base station apparatus includes a control unit configured to create system information including reception resource pool information to be used for the D2D wireless communication in a single radio frame, resource block information for the D2D wireless communication, and PUCCH information to be used for a cellular communication and a downlink transmission unit configured to broadcast the created system information to devices for performing the cellular communication and the D2D wireless communication.

In accordance with another aspect of the present disclosure, a communication method of a device in a wireless communication system which supports a D2D wireless communication is provided. The communication method includes receiving system information including reception resource pool information to be used for the D2D wireless communication in a single radio frame, resource block information for the D2D wireless communication, and PUCCH information to be used for a cellular communication and performing the cellular communication or the D2D wireless communication, based on the received system information.

In accordance with another aspect of the present disclosure, a device apparatus for performing a D2D wireless communication in a wireless communication system which supports a cellular communication and the D2D communication is provided. The device apparatus includes a downlink reception unit configured to receive system information from a base station, a transmission unit configured to transmit data of the cellular communication or data of the D2D wireless communication, and a control unit configured to obtain reception resource pool information to be used for the D2D wireless communication in a single radio frame, resource block information for the D2D wireless communication, and PUCCH information to be used for a cellular communication from the system information, to receive resource allocation based on the obtained information, and to control the transmission unit to perform the cellular communication or the D2D wireless communication through allocated resource.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating the allocation of resources for a communication in a Long Term Evolution (LTE) Device-to-Device (D2D) system according to an embodiment of the present disclosure;

FIG. 2 is a schematic diagram illustrating an In-Band Emission (IBE) issue caused when a cellular Physical Uplink Control Channel (PUCCH) and a D2D Physical Uplink Shared Channel (PUSCH) use resources divided by Frequency Division Multiplexing (FDM) in a D2D discovery or a D2D direct communication according to an embodiment of the present disclosure;

FIGS. 3A and 3B are simulation graphs illustrating an interference phenomenon caused by an IBE issue according to an embodiment of the present disclosure;

FIGS. 4A and 4B are diagrams illustrating an inter-carrier interference (ICI) issue caused when a cellular PUCCH and a D2D PUSCH use resources divided by FDM in a D2D discovery or a D2D direct communication according to an embodiment of the present disclosure;

FIG. 5 is a diagram illustrating an Inter-Symbol Interference (ISI) issue caused when a cellular PUCCH and a D2D PUSCH use resources divided by FDM in a D2D discovery or a D2D direct communication according to an embodiment of the present disclosure;

FIGS. 6A, 6B, 6C, and 6D are diagrams illustrating some cases of using a guard Resource Block (RB) for solving IBE and ICI issues according to an embodiment of the present disclosure;

FIGS. 7A and 7B are diagrams illustrating some cases of using a guard RB for solving IBE and ICI issues according to another embodiment of the present disclosure;

FIG. 8 is a block diagram illustrating a D2D transmitting device according to an embodiment of the present disclosure;

FIG. 9 is a flow diagram illustrating a transmission control operation for solving an ISI issue at a D2D transmitting device according to an embodiment of the present disclosure;

FIG. 10 is a block diagram illustrating a base station allowing a D2D communication according to an embodiment of the present disclosure; and

FIG. 11 is a flow diagram illustrating a control operation for solving an ISI issue at a base station according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

First of all, standardization matters under discussion in the Long Term Evolution (LTE) system with regard to the Device-to-Device (D2D) communication scheme will be described hereinafter. Additionally, some issues based on such discussion in the LTE system will be described in detail hereinafter.

LTE-based D2D communication technologies may be classified into a D2D discovery and a D2D communication. The D2D discovery refers to a procedure in which a certain device identifies the identity or interest of other adjacent devices or offers its own identity or interest to other adjacent devices. In this case, the identity and the interest may be a device identifier, an application identifier, a service identifier, or the like, which can be formed depending on D2D services and related operation scenarios.

In case of using a D2D type, it is supposed that a hierarchical structure of a device is formed of a D2D application layer, a D2D management layer, and a D2D transmission layer. The D2D application layer refers to a D2D service application running in the Operating System (OS) of the device. The D2D management layer performs a function to convert discovery information, created in the D2D application, into a suitable format for the transmission layer. The D2D transmission layer refers to a physical (PHY)/Media Access Control (MAC) layer of the LTE or WiFi wireless communication standard.

The D2D discovery may have the following process. If a user executes a D2D application, information for discovery is created on the D2D application layer and transferred to the D2D management layer. Then, the D2D management layer converts the discovery information, transferred from the D2D application layer, into a D2D management layer message. This D2D management layer message can be transmitted through the D2D transmission layer. The device may perform a process of receiving such a message in reverse order of the transmission process.

Meanwhile, the D2D communication refers to a way of transferring traffic directly between devices without passing any infrastructure such as a base station (sometimes referred to as evolved node B (eNB)) or an access point (AP). The D2D communication may be performed between devices discovered as a result of the D2D discovery process, or alternatively performed without passing the D2D discovery process. It may depend on D2D services and related operation scenarios whether to require the D2D discovery process before the D2D communication.

The D2D service scenarios can be classified mainly into a commercial service (or non-public safety service) and a public safety service. Such services may include, for example, but not limited to, an advertisement service, a Social Network Service (SNS), a game service, and a public safety service. Now, various respective services will be described below in more detail.

(1) Advertisement Service: A communication network operator that supports D2D can allow pre-registered stores, cafes, cinemas, restaurants, or the like to advertise their identity to adjacent D2D users by using the D2D discovery or the D2D communication. In this case, interested matters may be promotion, event information, or discount coupons of advertisers. If such an identity is identical to user's interested matter, the user may visit the relevant store or the like and then obtain further information by using the existing cellular communication network or the D2D communication. In another example, an individual user may find a neighboring taxi through the D2D discovery and then send or receive data about destination or taxi fare through the existing cellular communication or the D2D communication.

(2) SNS: A user may send his or her application and interested matters about the application to adjacent other users. In this case, the identity or interested matter used for the D2D discovery may be a friend list of the application or an application identifier. The user may perform the D2D discovery and then share contents such as photos or videos with the adjacent users.

(3) Game Service: A user may enjoy mobile games with adjacent users. In this case, the user may find other users and game applications through the D2D discovery and then perform the D2D communication so as to transmit data required for a game.

(4) Public Safety Service: Police officers or fire fighters may use the D2D communication for public safety. Namely, in case of emergency, such as a fire or a landslide, or in case of any unavailable cellular communication or failure in the existing cellular network due to natural disasters or other emergency events, police officers or fire fighters may use the D2D communication in order to find nearby emergency responder colleagues or share emergency information with other users.

With regard to such D2D communication schemes which can offer various type services, the standardization is now under discussion. The 3rd Generation Partnership Project (3GPP) LTE standardization organization is one of representative groups of discussing such standardization. In this 3GPP LTE standardization organization, the standardization about both the D2D discovery and the D2D communication is now in progress. The D2D discovery aims at a commercial use and should be designed to operate in network coverage of a base station. Namely, the D2D discovery is not supported in a situation without a base station or out of network coverage. The D2D communication aims at a public safety service rather than a commercial use and should be always supported in network coverage, out of network coverage, and in partial network coverage (namely, a situation in which some devices exist in network coverage and the others exist out of network coverage). Therefore, in the public safety service, the D2D communication should be performed without the support of D2D discovery.

In the LTE D2D for which the standardization is now proceeding, both the D2D discovery and the D2D communication are performed on an uplink subframe of LTE. Namely, a D2D transmitter transmits a D2D discovery signal and D2D communication data through the uplink subframe, and also a D2D receiver receives them through the uplink subframe. In a current LTE system, a device receives data and control information through the downlink from a base station and transmits them through the uplink to a base station. Therefore, transmission/reception operations of the D2D device may be different from those of the existing LTE. For example, a device which fails to support a D2D function has an Orthogonal Frequency Division Multiplexing (OFDM)-based receiver for receiving downlink data and control information from a base station, and also this device needs a Single Carrier-FDM (SC-FDM)-based transmitter for transmitting uplink data and control information to a base station.

However, a D2D device having to support both a cellular mode and a D2D mode should have an OFDM-based receiver for receiving the downlink from a base station, an SC-FDM-based transmitter for transmitting data and control information or transmitting D2D data and control information to a base station through the uplink, and also an additional SC-FDM receiver for receiving D2D data and control information through the uplink.

In a current LTE D2D, two types of the D2D discovery are defined according to resource allocation.

(1) Type 1 discovery: A base station broadcasts an uplink resource pool available for the D2D discovery to all D2D devices in a cell through a System Information Block (SIB). At this time, the base station may broadcast information such as the size of D2D available resources, e.g., sequential x subframes, and the period of resources, e.g., the repetition of y seconds. D2D transmitting devices that receive this information select resources to be used dispersively and transmit a D2D discovery signal.

In this case, the D2D transmitting devices may use various methods of selecting resources. One simple example is a random resource selection method. Namely, the D2D transmitting device that intends to transmit a D2D discovery signal randomly selects resources in the Type 1 discovery resource region obtained through SIB.

Another method is based on energy sensing. Namely, a D2D transmitting device for transmitting a D2D discovery signal may sense energy levels of all resources (i.e., resource blocks (RBs)) in the Type 1 discovery resource area obtained through SIB. Then the device may select a specific RB having the lowest energy level, or select a specific RB having an energy level equal to or lower than a specific threshold value. Alternatively, the device may sort RBs having an energy level equal to or lower than a specific threshold value and then select randomly a specific resource from the sorted RBs. After selecting a resource, the D2D transmitting device transmits a discovery signal to the RB selected in the Type 1 discovery resource area.

Meanwhile, D2D receiving devices decode all D2D discovery signals transmitted from a resource pool contained in SIB information. In case of the Type 1 discovery, all devices which are in the RRC_Idle mode and in the RRC_Connected mode allow D2D transmission/reception. For example, the D2D receiving devices that recognize through SIB decoding that sequential x subframes are repeated every y seconds perform decoding of all RBs allocated for the D2D discovery in the sequential x subframes.

(2) Type 2 discovery: A base station informs, through SIB, a pool of discovery signal resources that should be received by D2D receiving devices. Meanwhile, transmission discovery signal resources for D2D transmitting devices are scheduled by a base station. Namely, the base station orders the D2D transmitting devices to perform transmission at a specific time-frequency resource. In this case, scheduling by the base station may be performed through a semi-persistent scheme or a dynamic scheme. For this operation, the D2D transmitting device should request a D2D transmission resource such as a Scheduling Request (SR) or a Buffer Status Report (BSR) from a base station. Further, in order to use the Type 2 discovery, the D2D transmitting device should be in the cellular RRC_Connected mode. Namely, the D2D transmitting device which has been in the RRC_Idle mode should enter the RRC_Connected mode through a random access procedure for a D2D transmission resource request. Allocation information about D2D transmission resources of a base station may be transmitted to each D2D transmitting device through an RRC_signaling or (enhanced) Physical Downlink Control Channel ((e) PDCCH).

Additionally, the D2D communication may be classified into two types according to resource allocation as being similar in the D2D discovery.

(1) Mode 1: A base station or a Release 10 relay informs directly a resource for transmission of data and control information for the D2D communication used by a D2D transmitter. Also, using SIB, the base station informs a pool of D2D signal resources that should be received by a D2D receiving device.

(2) Mode 2: Based on resource pool information obtained for transmission of data and control information, the D2D transmitter dispersively selects and transmits a resource in the resource pool. At this time, as discussed in the Type 1 discovery, a resource selection method may be a random resource selection or an energy-sensing based resource selection.

The present disclosure provides a method for reducing various interference issues, e.g., In-Band Emission (IBE), Inter-Carrier Interference (ICI), and Inter-Symbol Interference (ISI), caused when the cellular system supports the D2D discovery or the D2D direct communication.

Now, the cause of these issues will be described hereinafter.

Timing Advance (TA) will be described first. In the existing cellular communication, a plurality of devices (also referred to as User Equipment (UE) etc.) may exist in a cell covered by a base station (also referred to as evolved Node B, eNB, etc.). Since these devices are disposed at different locations within the cell coverage of a specific base station, a distance between a base station and each device may be different. Therefore, in order to receive data and control information from devices through the uplink at the same time, a base station transmits a TA value to reach device. This TA value may be varied according to a Round Trip Delay (RTD) between a base station and a device. For example, some devices located near a base station have a smaller value of RTD, so that the base station notifies a smaller TA value to such devices. On the contrary, other devices located far from the base station have a greater value of RTD, so that the base station notifies a greater TA value to such devices.

Devices that receive a TA value drive a timer embedded therein and then obey a command of the received TA value until the timer expires in so far as other command is not received from a base station. Namely, data and control information transmitted to a base station from a device through the uplink should be based on a TA value until the expiry of the timer.

Next, Transmit Power Control (TPC) will be described. In the cellular communication, a base station performs a TPC in order to receive data and control information, in similar sizes, transmitted through the uplink from devices disposed at different locations within the cell coverage. For example, devices located near a base station are commanded to use lower transmission power, and other devices located far from the base station are commanded to use higher transmission power. This power control may facilitate an Automatic Gain Control (AGC) of a base station receiver. Namely, since a receiver AGC has a limitation in dynamic range, a signal having higher received signal strength may be clipped or a signal having lower received signal strength may be not detected when a transmission signal is received from a device having different levels of power by an AGC input. This may cause IBE.

Next, in case of using OFDM or SC-FDM, a length of cyclic prefix (CP) inserted in transmitting data will be described. The LTE system supports two types of CP length, i.e., normal CP and extended CP. These CP lengths may be set up by operators according to the cell coverage and cell channel environment. For example, in case of smaller cell coverage and smaller channel delay spread, the normal CP may be used. On the contrary, in case of greater cell coverage and greater channel delay spread, the extended CP may be used. In the LTE system, the length of downlink CP is notified to devices without any special signaling, and each device may detect blindly the downlink CP length in a detection process of Primary Synchronization Signal (PSS) and Secondary Synchronization Signal (SSS) for downlink synchronization with a base station.

Meanwhile, the uplink CP length is configured for all devices in a cell through SIB2. Like this, the LTE system gives the flexibility of system design so as to use the uplink CP length and the downlink CP length differently.

In the existing cellular system, e.g., the LTE system, a device receives data and control information from a base station through the downlink and transmits them to the base station through the uplink.

However, in the LTE-based D2D system, the D2D discovery and the D2D direct communication are performed in the uplink subframe. Namely, a D2D transmitting device transmits data and control information for the D2D discovery and the D2D direct communication in the uplink subframe, and also a D2D receiving device receives data and control information for the D2D discovery and the D2D direct communication in the uplink subframe. Resources for transmitting a D2D discovery signal and a D2D direct communication may be used by FDM within the same subframe as a Physical Uplink Shared Channel (PUSCH) for uplink data transmission of the existing cellular device or a Physical Uplink Control Channel (PUCCH) which is an uplink feedback channel of the device.

When D2D resources are used together with resources of the existing cellular device by frequency-dividing the same subframe, in LTE-based D2D technology the D2D device uses the maximum transmission power so as to increase a coverage or range of the D2D discovery and the D2D direct communication. In this case, transmission signals (i.e., a discovery signal and a communication signal) of the D2D device may cause an IBE issue to a base station that receives PUCCH or PUSCH transmitted from the existing cellular device. Namely, a base station performs a power control such that PUCCH or PUSCH transmitted through the uplink by a cellular device can be received consistently without getting out of a dynamic range of AGC gain of a base station receiver. If a signal transmitted by a D2D device located near a base station has greater power strength, the AGC gain of a base station receiver is adjusted and thereby the base station receiver does not receive PUCCH or PUSCH transmitted to the base station through the uplink by a cellular device. This is referred to as an IBE issue.

One solution of the IBE issue is a power control of a D2D transmitting device. However, this power control is not desirable in the D2D system. Normally, in the cellular system, a base station notifies various parameters required for an uplink transmission power control to devices, or a device sets up transmission power by predicting some parameters to determine transmission power thereof In order to determine these parameters, by the help of a device, a base station measures the quality of a channel between the base station and the device, e.g., received signal strength, and a channel quality which may influence the base station and the device, e.g., interference signal strength, and then reflects the measured quality on a transmission power control. This concept may be applied to a transmission power control of a D2D device. Namely, for a transmission power control of a D2D device, channel information, e.g., received signal strength and interference signal strength, is collected from adjacent channels and used.

It is difficult, however, to directly apply a normal transmission power control of the cellular system to the D2D system. Specifically, in the cellular system, a receiving end of the uplink is a fixed base station. Therefore, average noise and interference received from adjacent cells may be measured consistently. However, in the D2D system, a receiving end is a mobile device. Thus, it is difficult to measure consistently average noise and interference received from adjacent devices. Besides, there are following issues when a transmission power control is applied to the D2D system.

First, a large amount of information to be exchanged for the measurement of a channel quality may be overhead.

Second, another issue such as a D2D configuration change of device pairs for the D2D communication may arise.

Basically, for a transmission power control, information about a channel quality between transmitting and receiving ends and information about average noise and interference at a receiving end are needed. Additionally, for a transmission power control of a D2D device, interference arising at a cellular base station by a D2D transmitting device, interference arising at a D2D receiving device by a cellular device, and interference arising at other D2D receiving device by the D2D transmitting device should be measured. Since the quality of too many channels should be measured, a large amount of information to be exchanged may often invite overhead. This issue may become further serious in a D2D discovery and D2D data multicast/broadcast scenario in which a single transmitter and multiple receivers transmit and receive data.

Meanwhile, even though it is supposed that the quality of all the above-discussed channels can be measured, a configuration change of device pairs for the D2D discovery and communication and the mobility of D2D device may be varied when a measured quality value of channel is applied. This may deteriorate the system performance. Therefore, the above-discussed transmission power control based on measurement of a channel quality may be not a good solution to an IBE issue in the D2D system.

Meanwhile, in the Rel-12 D2D standardization, PUSCH for transmitting a D2D signal starting from a D2D device and PUCCH transmitted by the existing cellular device may be used by FDM in the same subframe. PUCCH transmission of the existing cellular device is made on the basis of TA in response to a command of a base station. For example, a cellular device located near a base station performs such transmission with a smaller TA value, and a cellular device located far from a base station performs such transmission with a greater TA value. However, in the D2D discovery or the D2D Mode 2 communication, for supporting an RRC_Idle mode device, a D2D signal is transmitted according to a downlink transmission reference timing rather than an uplink transmission reference timing (based on TA). Namely, after receiving downlink PSS/SSS transmitted from a base station and performing downlink synchronization, the device transmits a D2D signal on the basis of a downlink time.

In this case, PUCCH is transmitted according to uplink reference timing based on TA, and D2D PUSCH is transmitted according to downlink reference timing. Therefore, in case PUCCH and D2D PUSCH are used by FDM in the same subframe, D2D PUSCH causes an ICI issue in PUCCH reception at a base station. Additionally, for a flexible operation, D2D PUSCH and PUCCH may use different CP lengths. In case different CP lengths are used in the same subframe, PUCCH and D2D PUSCH may use respective CPs of different lengths, for example, normal CP and extended CP. Compared that PUCCH and D2D PUSCH use the same CP length, D2D PUSCH causes much more ICI issue in PUCCH received by a base station. For the coexistence of a D2D device and the existing cellular device, such an ICI issues should be solved.

Meanwhile, when D2D PUSCH and existing cellular PUSCH are used by Time Division Multiplexing (TDM), D2D PUSCH causes an ISI in cellular PUSCH. For example, consider a case that D2D PUSCH is transmitted in the n-th subframe at downlink reference timing and that cellular PUSCH is transmitted in the (n+1)-th subframe at uplink reference timing. Since D2D PUSCH is transmitted according to downlink reference timing, if D2D PUSCH receives PSS/SSS after a propagation delay of T1 in the n-th subframe, D2D PUSCH of the n-th subframe is received at a base station after a propagation delay of 2*T1. If this propagation delay time is greater than a CP length of the (n+1)-th subframe, D2D PUSCH causes an ISI issue in cellular PUSCH. Therefore, for the coexistence of D2D device and existing cellular device, such an ISI issues should be solved.

Now, a method for solving the above-discussed issues in the present disclosure, together with an apparatus for implementing the method, will be described hereinafter.

In the present disclosure, one method is provided for solving IBE and ICI issues caused by D2D PUSCH in reception of a PUCCH signal at a base station when D2D PUSCH and PUCCH, i.e., a feedback channel of a cellular device, are used by means of FDM. Another method is provided for solving an ISI issue caused by D2D PUSCH in reception of a cellular PUSCH signal at a base station when D2D PUSCH and cellular PUSCH, i.e., a data channel of a cellular device, are used by means of TDM. In other words, the present disclosure is summarized as follows:

First, a method and apparatus for solving an IBE issue that arises in case a cellular uplink resource (i.e., cellular PUSCH or cellular PUCCH) performing a transmission power control and a D2D resource (i.e., D2D PUSCH) performing no transmission power control are used together by means of FDM;

Second, a method and apparatus for solving an ICI issue that arises in case a resource, such as cellular PUSCH, cellular PUCCH, or a D2D discovery and D2D communication resource, transmitted on the basis of uplink (UL) transmit reference timing (TA) and a D2D discovery and D2D communication resource transmitted on the basis of downlink (DL) transmit reference timing are used together by means of FDM; and

Third, a method and apparatus for solving an ISI issue that arises in case a D2D discovery and D2D communication resource transmitted on the basis of DL transmit reference timing and a cellular PUSCH or a D2D discovery and D2D communication resource transmitted on the basis of UL transmit reference timing (TA) are used together by means of TDM.

Although the above-discussed method and apparatus may be provided to solve a specific issue, two or more issues may be solved through a single method and apparatus given above.

A D2D device may acquire resource allocation information for D2D discovery and communication through SIB. Namely, a base station transmits, through SIB, resource allocation information to D2D devices disposed in a cell thereof In this case, resource allocation information contained in SIB is as follows.

(1) Resource pool for reception: Type 1 discovery and Type 2 discovery use the same reception resource pool.

(2) Discovery period: This refers to the cycle of discovery resource allocation.

(3) Number of subframes: This indicates how many subframes constitute a reception resource pool that exists in a single discovery period. Further, the number of time-axis resources may be offered.

(4) Number of Physical RBs (PRBs): This informs the number of resources on the frequency axis.

(5) Transmission resource pool for Type 1 discovery

Now, solutions to the above-discussed issues will be described according to embodiments of the present disclosure.

Method for solving IBE or ICI

A method for solving an IBE or ICI issue may be varied depending on whether to use a guard band or a guard RB between cellular PUCCH and D2D PUSCH.

(1) Case of using a Guard Band:

Various options are available depending on the bandwidth of existing cellular PUCCH and D2D PUSCH, namely, depending on a variation in the number of RBs that occupy PUCCH and D2D PUSCH.
Option 1: The bandwidth of existing cellular PUCCH and D2D PUSCH is fixed. Therefore, the number of guard RBs is unchanged in all subframes. The reason is that the number of guard RBs required for solving IBE and ICI issues may be varied according to the number of RBs allocated to D2D PUSCH. Namely, if many RBs are allocated to D2D PUSCH, IBE and ICI issues become more serious and thus much more guard RBs are needed. In Option 1, D2D PUSCH has the same bandwidth in all subframes, so that the number of guard RBs can be fixed. In option 1, the number of D2D resources on the frequency axis may be unchanged in all subframes, so that signaling overhead for resource allocation may be reduced. However, a flexible use depending on D2D load is difficult.
Option 2: The bandwidth of existing cellular PUCCH and D2D PUSCH may be varied for each subframe, and the number of guard RBs is preferable to be varied in every subframe. Namely, if the bandwidth of D2D PUSCH is greater, the number of guard RBs may increase. Similarly, if the bandwidth of D2D PUSCH is smaller, the number of guard RBs may decrease. In Option 2, since the bandwidth of D2D PUSCH may be varied for each subframe, signaling for D2D resource allocation should contain the number of D2D resources on the frequency axis in each subframe. In this case, a flexible use depending on D2D load may be allowed, but signaling overhead may increase.

(2) In Case of using No Guard Band

The previous method introduces a guard RB to solve an IBE or ICI issue that arises at PUCCH by D2D PUSCH. Contrary to that, in this example, D2D PUSCH transmitted at uplink transmit reference timing, e.g., Mode 1 communication, is allocated to a RB being closer to PUCCH. Namely, a D2D resource is allocated to only a D2D transmitting device which may not affect reception of PUCCH at a base station. For example, if a Mode 1 resource is allocated such that D2D devices being closer to a base station (i.e., eNB) among RRC_Connected UE can transmit, an IBE or ICI issue may be relieved. Namely, devices located near a base station have no significant difference between uplink transmit timing (i.e., UL TX timing) and downlink timing (i.e., DL timing) Therefore, an ICI issue may decrease. Also, in case of Mode 1 discovery, a base station (i.e., eNB) may not invite an IBC or ICI issue in PUCCH reception since the base station can control transmit power.

Resource allocation of D2D PUSCH transmitted at downlink transmit reference timing may have two options depending on whether to equally maintain frequency-axis resources (i.e., the number of RBs) allocated for D2D PUSCH in all D2D subframes as discussed previously in use of a guard band or to use different numbers of RBs for each D2D subframe.

Since an ICI issue may be solved through the above-discussed methods, a flexible use of CP becomes possible. Namely, as downlink CP length and uplink CP length may be used differently in the existing LTE cellular communication, a flexible use of CP is allowed in the D2D communication. For example, D2D devices located around a cell edge may forward D2D Synchronization Signal (D2DSS) and Physical D2D Synchronization Channel (PD2DSCH) to out-of-coverage D2D devices in response to a command of a base station or by the determination of device themselves. In this case, the out-of-coverage devices may receive PD2DSCH after detecting CP length in a process of D2DSS discovery. Then the out-of-coverage D2D devices decode PD2DSCH and use CP configuration information, contained in PD2DSCH, for Scheduling Assignment (SA) or CP creation for transmission of D2D data.

Meanwhile, in a cell covered by a base station, different CP lengths may be used by D2D PUSCH and D2D signals (e.g., D2DSS, D2D preamble) used for the D2D discovery and D2D direct communication and by cellular channels (e.g., PUSCH, PUCCH, etc.) and cellular signals (PSSS, SSS, etc.) used for the cellular communication. For example, in case of performing the D2D discovery and D2D communication in a cell having small cell coverage, the cellular system may use normal CP capable of fully covering the small cell coverage. In this case, extended CP may be used for D2D coverage in the D2D discovery and D2D communication. This CP length information may be broadcasted to cellular devices and D2D devices through SIB, as follows:

UL-CyclicPrefixLength::=ENUMERATED {len1, len2}

D2D-CyclicPrefixLength::=ENUMERATED {len1, len2}

Here, len1 denotes normal CP, and len2 denotes extended CP.

Meanwhile, a device located in base station coverage may insert information about CP length in PD2DSCH and then transmit it to out-of-coverage devices. In this case, the CP length for SA and for D2D data transmission/reception may be equal to each other or different from each other. Therefore, 1-bit information indicating the CP length of SA (e.g., 0 indicates normal CP and 1 indicates extended CP) and 1-bit information indicating the CP length of D2D data (e.g., 0 indicates normal CP and 1 indicates extended CP) may be contained in PD2DSSCH.

Method for solving ISI

TS36.211, which is one of the 3GPP LTE standards, defines TA operation as follows: the transmission of the uplink i-th frame of specific UE begins at (N_{TA}+N_{TAoffset})×TS second before the start of uplink frame in that UE. Here, N_{TA} may have the range of 0≦N_{TA}≦20512, and N_{TAoffset} is defined as 0 in the Frequency Division Duplexing (FDD) system and as 624 in the Time Division Duplex (TDD) system. Also, TS=1/(15000×2048) second. Through this, the LTE system defines various TA values, and this TA value may be varied depending on cell coverage.

In case D2D PUSCH and cellular PUSCH are used by means of TDM, transmit timing of D2D PUSCH is based on downlink reference timing, and transmit timing of cellular PUSCH is based on uplink reference timing (based on TA). In this case, an ISI issue may arise due to a collision on the time axis between symbols constituting D2D PUSCH and PUSCH. For solving this ISI issue, a guard period may be used for subframe which forms D2D PUSCH. The length of a guard period may be varied depending on how many symbols undergo ISI and finally depending on the location of a D2D device and TA value (i.e., cell coverage) of a cellular device. Therefore, two options for preventing ISI may be considered as follows.
Option 1: Method of varying a guard period depending on cell coverage.

In order to allow a flexible use depending on cell coverage, a guard period, e.g., the number of guard symbols, may be informed through SIB. In this case, the guard symbol is located in D2D subframe when there are both D2D subframe operating based on downlink reference timing and cellular subframe operating based on uplink reference timing. Alternatively, when there are both D2D subframe operating based on downlink reference timing and D2D subframe or cellular subframe operating based on uplink reference timing, a guard period may be located in the last D2D discovery subframe operating based on downlink reference timing or in the first subframe from among subframes operating based on uplink reference timing.
Option 2: Method of using a guard period having the same size regardless of cell coverage.

In Option 1, even though a flexible use is supported, a TA value increases when cell coverage increases. This requires a large number of guard symbols and thus D2D resources are wasted. Therefore, an ISI issue can be solved through the operation of a base station or device, using guard symbols fixed in number regardless of cell coverage. In this case, a fixed number of guard symbols may be determined through two methods given below.

One method is to set the guard symbol, as a default, in a D2D device. The other is to enable a device to set the guard symbol by broadcasting it to devices through base station signaling, e.g., SIB.

First, in the case of setting a default, a D2D transmitting device recognizes that there are a predetermined number of guard symbols between a subframe (e.g., Type 1/Type 2B discovery/Mode 2 communication) operating based on downlink reference timing and a subframe (Mode 1 communication, cellular PUCCH/PUSCH) operating based on uplink reference timing, and then performs puncturing of each guard symbol. This puncturing may be performed before or after data mapping. For example, consider the case that the size of resources (RBs) used by a D2D transmitting device is 12 subcarriers on the frequency axis and 14 symbols on the time axis (i.e., 12×14=168 tones), and that the last one symbol is defined as a guard symbol. In this case, the transmitting device may perform puncturing of the last one symbol and then perform data mapping of 12×13 tones, or alternatively may perform data mapping of 12×14 tones and then perform puncturing of the last one symbol.

Second, the operation of using base station signaling is as follows. A base station broadcasts the number of guard symbols, required by a cell thereof, to D2D devices through signaling. For example, consider the case that the number of guard symbols is N. Considering cell coverage, the value of N may be set to a smaller number than necessary. For example, if cell coverage is 10 km and if 4 guard symbols are needed, a base station may broadcast the use of two guard symbols to D2D devices.

Additionally, if more guard symbols are required than those defined as a default or if more guard symbols are required than two guard symbols defined by a base station, this may be solved through the operation of a base station or device, as follows:

A. The operation of a D2D device that performs transmission at downlink transmit reference timing.

i. When a D2D device is in an RRC_Connected mode:

Consider the case that the n-th subframe is allocated for D2D, and the (n+1)-th subframe is allocated for cellular. A D2D device has an N_{TA} value because of being in the RRC_Connected mode. Therefore, if it is determined that the N_{TA} value is greater than a predefined threshold 1, a D2D discovery or communication signal is not transmitted in the n-th subframe. Namely, if indexes of subframe allocated for the D2D discovery or communication are n-3, n-2, n-1, and n, a D2D transmitting device (N_{TA}>threshold 1) performs D2D transmission by selecting resources from the n-3, n-2, and n-1 subframes except the n-th subframe. For this restriction, a base station may inform the value of threshold 1 as configuration information to D2D devices through SIB, or the value of threshold 1 may be fixed in a system so as to reduce signaling overhead. Therefore, using this configuration information, D2D devices may operate according to restrictions.

Meanwhile, such restrictions may be imposed on some subframes other than the n-th subframe. For example, consider the case that indexes of a subframe allocated for the D2D discovery or communication are n-3, n-2, n-1, and n, and that these D2D resources are repeated per X subframes. Namely, a period is (n-3, n-2, n-1, n), (X+n-3, X+n-2, X+n-1, X+n), (2X+n-3, 2X+n-2, 2X+n-1, 2X+n), and the like. At the first period, a D2D transmitting device having N_{TA} >threshold 1 does not perform D2D transmission in all subframes (n-3, n-2, n-1, n) allocated for D2D, and compares its own N_{TA} value with threshold 1 value at the time that the next D2D resources are allocated (X+n-3, X+n-2, X+n-1, X+n). In this case, if N_{TA} >threshold 1, transmission is abandoned (D2D transmission is disallowed) at (X+n-3, X+n-2, X+n-1, X+n) and a comparison is performed again at the time that the next D2D resources are allocated. If N_{TA} >threshold 1 even though passing this process K times, a change to Type 2B discovery (Mode 1 communication) is requested to a base station. Here, K may be 1.

ii. When D2D device is in an RRC_Idle mode:

In the LTE system, if a device receives a TA command (e.g., a TA value, N_{TA}) from a base station, the device executes a TA timer embedded therein. Until the TA timer is terminated, the device transmits all data and control information through uplink on the basis of the TA command received from the base station. Therefore, RRC_Idle devices which have a threshold 1 value and an N_{TA} value abandon D2D transmission (D2D transmission is disallowed) at the n-th subframe. In other words, devices whose TA timer is not terminated abandon D2D transmission at the n-th subframe.

Devices having no N_{TA} value due to termination of a TA timer perform the operation based on downlink measurement with a base station. Namely, the device estimates a distance from the base station and, if the distance is too great, abandons D2D transmission (D2D transmission is disallowed) at the n-th subframe. The device may measure Reference Signal Received Power (RSRP) or Reference Signal Received Quality (RSRQ) by using PSS/SSS, Cell specific Reference Signal (CRS), Demodulation Reference Signal (DMRS), or the like from the base station and thereby can estimate the distance from the base station. At this time, for helping the operation of the RRC_Idle device, the base station may broadcast threshold values about a distance, RSRP, and RSRQ through SIB. If a distance value estimated by the device is greater than a threshold value, (i.e., in case a distance from the base station is great), D2D transmission may be abandoned. In another example, if RSRP and RSRQ measured by the device are smaller than a threshold value (i.e., in case power or quality of signal received from the base station is poor), D2D transmission may be abandoned. In most cases, poor power or quality of received signal may be caused by a long distance between the device and the base station.

Meanwhile, the abandonment of D2D transmission (D2D transmission is disallowed) includes the case of abandoning the transmission of the last subframe, the case of abandoning the transmission of all subframes allocated in the entire single period, and the case of requesting new resources, as being similar to operation when the D2D device is in the RRC_Connected mode. Also, the RRC_Idle mode device requires a random access operation for requesting new resources.

Next, the operation of a base station (eNB) will be described hereinafter.

First, in order to support the above-discussed operations, the base station may broadcast a predefined threshold value to all devices located in a cell through SIB.

Second, if a D2D device being in the RRC_Connected mode should perform a cellular communication at the (n+1)th subframe, D2D transmission should be abandoned (D2D transmission is disallowed) at the nth subframe since the N_{TA} value of the D2D device is greater than the threshold value. However, in response to a command of the base station, the device may not perform a cellular communication at the (n+1)th subframe.

Now, the above-discussed methods will be more fully described with reference to the drawings.

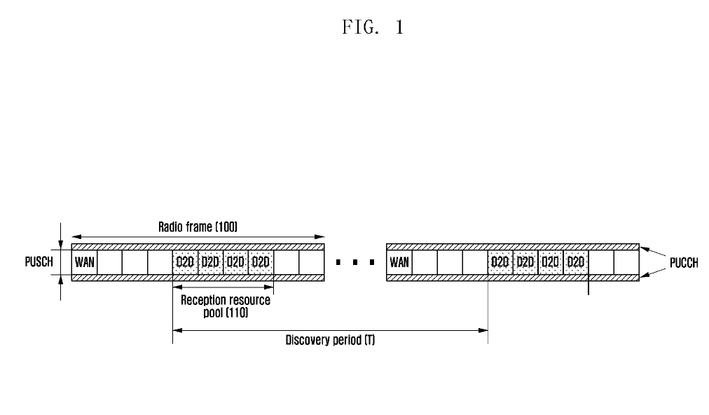

FIG. 1 is a diagram illustrating the allocation of resources for a Type 1/Type 2B or Mode 2 communication in an LTE D2D system according to an embodiment of the present disclosure.

Although FIG. 1 shows the FDD system, the present disclosure is not limited to the FDD system. The following description using the FDD system is exemplary only.

In the FDD system, DownLink (DL) and UpLink (UL) use different frequency bands. Resource allocation information for D2D is transmitted through SIB. In SIB, resources allocation information for Type 1 discovery, Type 2B discovery, or Mode 2 communication may be contained. Particularly, in case of Type 1 discovery and Type 2B discovery, the same reception resource pool may be used. Namely, a D2D receiving device merely receives all discovery signals transmitted from the reception resource pool configured through SIB without knowing whether the resource pool is for receiving Type 1 discovery or for receiving Type 2B discovery. SIB may contain the number of subframes configuring the resource pool, the number of RBs occupying the subframe, and a discovery period of the D2D resource pool.

Referring to FIG. 1, resources used in UL may be classified mainly by the unit of a radio frame 100, which is formed of a plurality of subframes. Each subframe is formed of PUCCH and PUSCH. As shown in FIG. 1, a certain radio frame may include a reception resource pool 110. The reception resource pool 110 may be disposed at each discovery period (T) offered as SIB information.

In case UL resources are configured as shown in FIG. 1, D2D devices match a downlink synchronization with a system through a synchronization signal, and then may receive information about an accessing cell by a Master Information Block (MIB) transmitted through a Physical Broadcast Channel (PBCH). For example, an MLB is formed of essential parameter information such as DL system bandwidth, system frame number, and a Physical Hybrid-ARQ Indication Channel (PHICH). The devices receiving the MIB may receive PDCCH transmitted from the base station at each subframe. Basically, PDCCH transmits DL/UL resource allocation information. Using a System Information—Radio Network Temporary Identifier (SI-RNTI), each device decodes allocation information of SIB resources that exist in PDCCH. Namely, the device becomes aware of information about a frequency-time region of SIB through PDCCH decoding using SI_RNTI (or D2D dedicated common RNTI, hereinafter, referred to as “D2D RNTI”), and then decodes SIB through decoding of the frequency-time region. By acquiring discovery subframe information contained in the SIB, the devices that successfully decode the SIB may determine which subframe(s) is for discovery and can also determine information about a discovery period (T) of a subframe. If the location of a subframe is changed within the relevant frame, for example, if a discovery frame is changed from the third subframe to the fifth subframe or if the number of discovery subframes is increased from one subframe to two subframes, such changing information may be transmitted through an SIB or paging channel. The device that transmits D2D discovery information may directly select a discovery resource from subframe(s) (Type 1), and the base station may select a discovery resource and then notify the selected resource to the device (Type 2B).

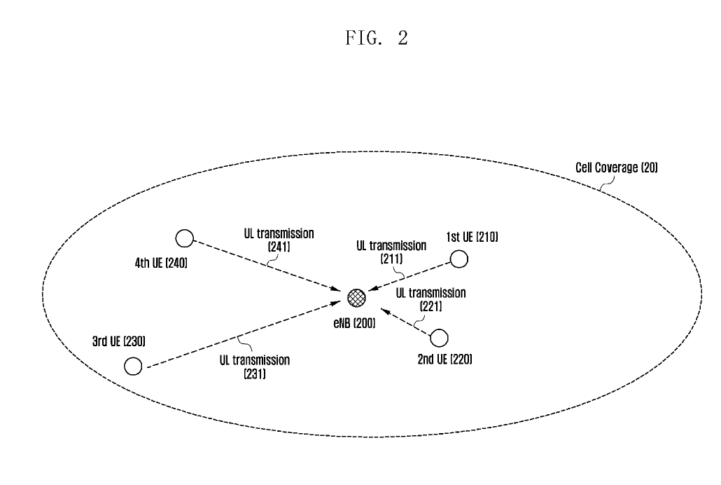

FIG. 2 is a schematic diagram illustrating an IBE issue caused when a cellular PUCCH and a D2D PUSCH use resources divided by FDM in a Type 1 discovery or a Mode 2 communication according to an embodiment of the present disclosure.

Referring to FIG. 2, a base station 200 (also referred to as eNB or the like) has a coverage area defined as certain cell coverage 20. Additionally, a plurality of devices (also referred to as UE or the like), such as the first device 210, the second device 220, the third device 230, and the fourth device 240, are disposed in the cell coverage 20 of the base station 200.

The first to fourth devices 210, 220, 230, and 240 may perform a communication with the base station 200, using UL resources. As shown in FIG. 2, communicating signals using UL resources are individually represented as UL transmission 211 of the first device 210, UL transmission 221 of the second device 220, UL transmission 231 of the third device 230, and UL transmission 241 of the fourth device. In this case, the UL transmission of each device may be data transmitted to the base station 200 or transmission in D2D resources as shown in FIG. 1.

At the D2D PUSCH transmission, D2D transmitting devices perform transmission with the maximum transmission power so as to secure discovery or communication range. If all the devices 210, 220, 230 and 240 shown in FIG. 2 are devices for transmitting a D2D signal, D2D signals transmitted by the first and second devices 210 and 220 located near the base station are received with high power at the base station 200.

Meanwhile, as discussed above, a power control is performed for a PUCCH signal transmitted by a cellular device in order to maintain a uniform reception power value at the base station. If there is a difference in a level of received signals, a receiver of the base station has difficulty in adjusting the gain of AGC. If the gain of AGC is matched to a received signal having lower power, a signal received with higher power is clipped and thereby distortion arises. On the contrary, if the gain of AGC is matched to a received signal having higher power, a signal received with lower power disappears. Due to these phenomena, although orthogonal frequency resources are used, signals out of a dynamic range about the gain of AGC may often cause interference to adjacent frequency resources. This is an IBE issue as discussed above.

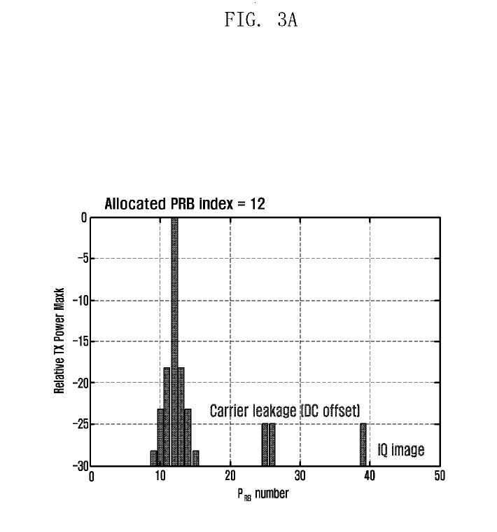

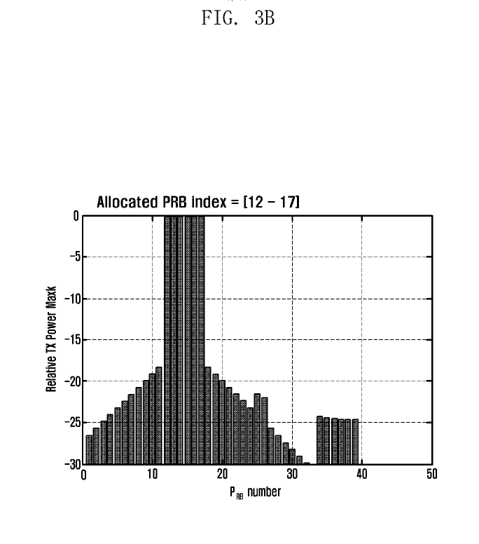

FIGS. 3A and 3B are simulation graphs illustrating an interference phenomenon caused by an IBE issue according to an embodiment of the present disclosure.

FIG. 3A shows case where a specific D2D device uses the twelfth RB, namely, uses a single RB. Referring to FIG. 3A, when the D2D device uses the twelfth RB, an IBE phenomenon in which stepwise interference is created at adjacent RBs is caused due to the D2D discovery or communication.

Additionally, FIG. 3B shows case where a specific D2D device uses the twelfth to seventeenth RBs, namely, uses six RBs. Referring to FIG. 3B, an IBE phenomenon in which stepwise interference is created at adjacent RBs is caused due to the D2D discovery or communication.

Making a comparison between FIGS. 3A and 3B, an IBE phenomenon arising at adjacent RBs is increased according as the RBs allocated for D2D discovery and communication are increased.

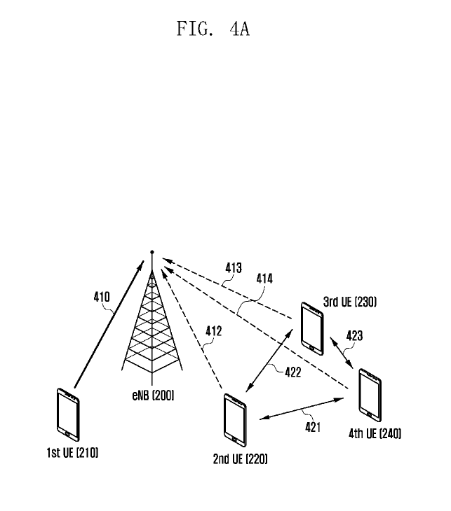

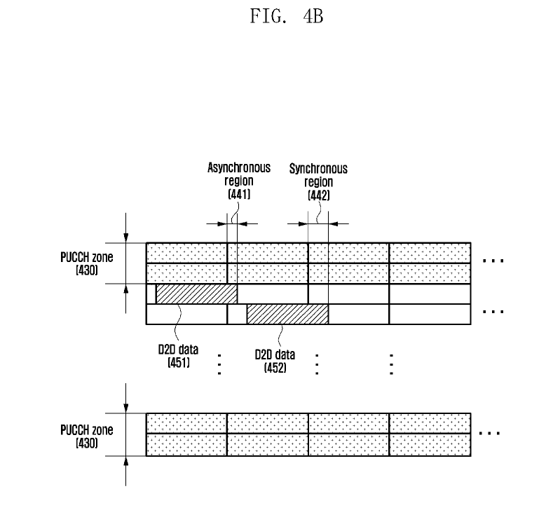

FIGS. 4A and 4B are diagrams illustrating an ICI issue caused when a cellular PUCCH and a D2D PUSCH use resources divided by FDM in a Type 1 discovery or a Mode 2 communication according to an embodiment of the present disclosure.

Referring to FIG. 4A, the first device 210 communicates with the base station 200, and the second, third, and fourth devices 220, 230, and 240 are available for the D2D communication in the cell coverage of the base station 200.

The first device 210 is a device for performing a cellular communication and may transmit PUCCH to the base station 200 as indicated by a reference numeral 410. In this case, PUCCH is transmitted on the basis of uplink timing based on TA as discussed above. The second, third, and fourth devices 220, 230, and 240 located in the cell coverage of the base station 200 may be devices for the D2D communication. These devices 220, 230 and 240 perform the communication through D2D PUSCH and transmit data through PUSCH on the basis of downlink reference timing. Therefore, the second, third, and fourth devices 220, 230, and 240 perform the communication by using different reference timing from that of the first device 210.

When the second, third, and fourth devices 220, 230, and 240 for performing the D2D communication transmit data through PUSCH, transmission based on downlink reference timing is no problem among the second, third, and fourth devices 220, 230, and 240. However, transmission signals of the second, third, and fourth devices 220, 230, and 240 may be also transmitted to the base station 200. For example, as shown in FIG. 4A, the second signal 412 transmitted from the second device 220 to the base station 200, the third signal 413 transmitted from the third device 230 to the base station 200, and the fourth signal 414 transmitted from the fourth device 240 to the base station 200 are not synchronized with PUCCH transmitted from the first device 210 to the base station 200. Similarly with signal 421 between the second device 220 and the fourth device 240, signal 422 between the second device 220 and the third device 230, and signal 423 between the third device 230 and the fourth device 240. Therefore, in view of the base station 200, the signals 412, 413, and 414 from the second, third, and fourth devices 220, 230, and 240 affect, as interference signals, the signal 410 transmitted from the first device 210 to the base station 200 through PUCCH. Therefore, D2D PUSCH causes an ICI issue to a receiving end of the base station for receiving cellular PUCCH.

Referring to FIG. 4B, there is a PUCCH zone 430 in UL configuration. Since the PUCCH zone 430 is synchronized with the base station 200 as discussed above, a signal is transmitted on the basis of TA offered by the base station. However, the second, third, and fourth devices 220, 230, and 240 for performing the D2D communication transmit D2D data 451 and 452 through PUSCH based on downlink reference timing, and thus asynchronous regions 441 and 442 are generated. Such asynchronous regions cause an ICI issue to the receiving end of the base station.

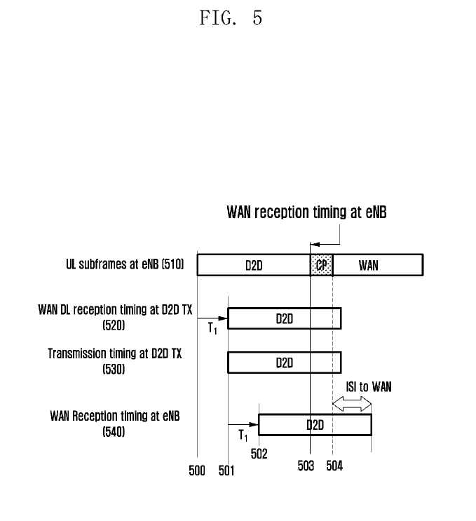

FIG. 5 is a diagram illustrating an ISI issue caused when a cellular PUCCH and a D2D PUSCH use resources divided by FDM in a Type 1 discovery or a Mode 2 communication according to an embodiment of the present disclosure.

Specifically, FIG. 5 shows a timing diagram illustrating UL subframes 510 at the base station, subframe 520 based on Wide Area Network (WAN) DL reception timing at the D2D transmitting device, subframe 530 based on transmission timing at the D2D transmitting device, and D2D subframe 540 received according to WAN reception timing at the base station.

At the base station, the reception timing of the UL subframes 510 may be indicated by reference numerals 500 and 503. Like this, the reception timing of each UL subframe is fixed at the base station since each device may have the TA value based on a distance from the base station as discussed above.

However, in case of the D2D device, the WAN DL reception timing may be different from the reception timing of the base station by a certain time, e.g., T₁ as shown in FIG. 5. This may be varied depending on a distance between the base station and the device. Therefore, the D2D device transmits a D2D subframe at reception timing as indicated by a reference numeral 501.

If the D2D device transmits a subframe as discussed above, the base station receives the subframe at a delayed time, i.e., T₁, which corresponds to a delayed time caused when the D2D device receives a WAN DL signal from the base station. In this case, if a CP region for preventing interference between symbols is defined from timing 503 to timing 504, ISI interference arises in a region received after timing 504.

Referring again to FIG. 5, if a D2D subframe (i.e., a Type 1 subframe) for transmitting a D2D signal based on downlink reference timing appears before a cellular subframe transmitted at uplink reference timing or a D2D subframe (i.e., a Type 2B subframe) transmitted at uplink reference timing, such D2D subframe may cause an ISI issue to the cellular subframe received at the base station. As shown in FIG. 5, if a base station PSS/SSS synchronism signal is received at D2D TX after a propagation delay of T₁, the D2D TX transmits the signal on the basis of relevant downlink timing Therefore, a D2D subframe transmitted by the D2D TX is received at the receiving end of the base station after a further propagation delay 502 of T₁. If any propagation delay of 2*T₁ in the D2D subframe deviates from CP length of the WAN subframe, the above-discussed ISI issue arises.

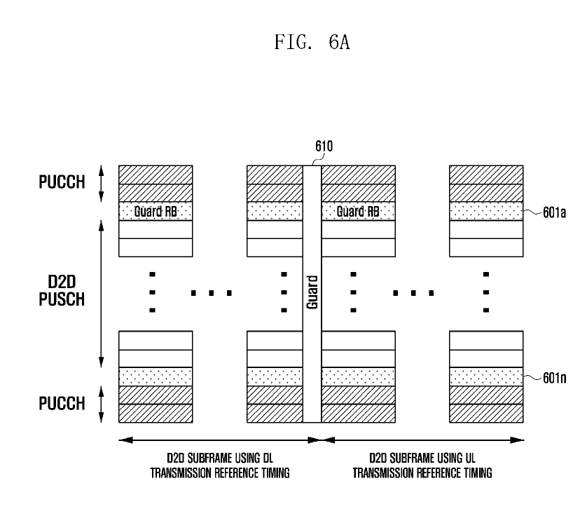

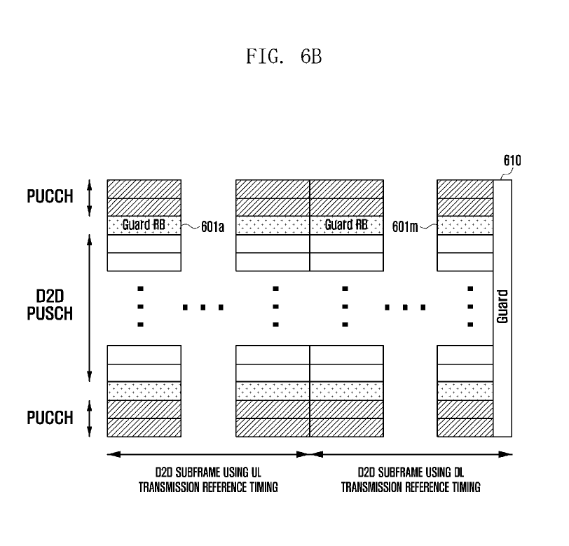

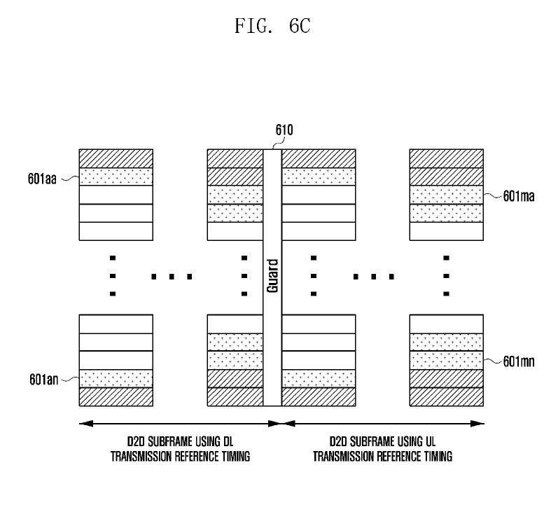

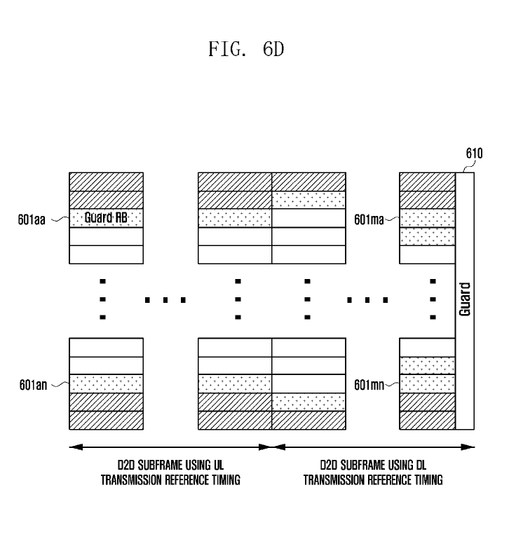

FIGS. 6A to 6D are diagrams illustrating some cases of using a guard RB for solving IBE and ICI issues according to an embodiment of the present disclosure.

FIGS. 6A and 6B show examples in which frequency-axis resources (i.e., the number of RBs) of D2D PUSCH are fixed and in which D2D subframe using downlink transmission reference timing and cellular subframe using uplink transmission reference timing are used by means of TDM.

Referring to FIGS. 6A and 6B, resources of PUCCH are fixed by two RBs at each periphery, and thus frequency-axis resources of D2D PUSCH are also fixed. In the case that frequency-axis resources of D2D PUSCH are fixed, IBE and ICI issues may be solved by placing guard RBs 601a, 601n and 601m in PUSCH frequency resources and PDSCH resources. This resource allocation may be performed by the base station or, if defined as the standard, set as a default in the device.

Additionally, in FIGS. 6A and 6B, a guard period 610 may be inserted between a D2D subframe using downlink reference timing and a cellular subframe using uplink reference timing. In this case, a D2D subframe using downlink reference timing and a cellular subframe using uplink reference timing may be changed in order. However, if a D2D subframe using downlink reference timing is allocated first, the last N symbols should be used as a guard symbol 610. Here, N may be fixed regardless of cell coverage, or varied depending on cell coverage. In the latter case, an N value should be broadcast through SIB.

FIGS. 6C and 6D show examples in which frequency-axis resources (i.e., the number of RBs) for a D2D subframe using downlink reference timing and for a cellular subframe using uplink reference timing are variable.

Referring to FIGS. 6C and 6D, PUSCH resources to be used for D2D are variable since peripheral PUCCH resources are varied. Therefore, as being similar with the above-discussed case, IBE and ICI issues may be solved by placing guard RBs 601aa, 601an, 601ma and 601mn in PUSCH frequency resources and PDSCH resources. Also, as shown, the number of guard RBs may be varied according to the number of RBs of the PUCCH. If possible, it is desirable that a single RB is allocated as a guard RB when a single RB is used in the PUCCH and also that two RBs are allocated as a guard RB when two RBs are used in the PUCCH.

Additionally, in FIGS. 6C and 6D, the guard period 610 may be inserted between a D2D subframe using downlink reference timing and a cellular subframe using uplink reference timing. As discussed above, a D2D subframe using downlink reference timing and a cellular subframe using uplink reference timing may be changed in order. However, if a D2D subframe using downlink reference timing is allocated first, the last N symbols should be used as a guard symbol 610. Here, N may be fixed regardless of cell coverage or varied depending on cell coverage. In the latter case, an N value should be broadcast through SIB.

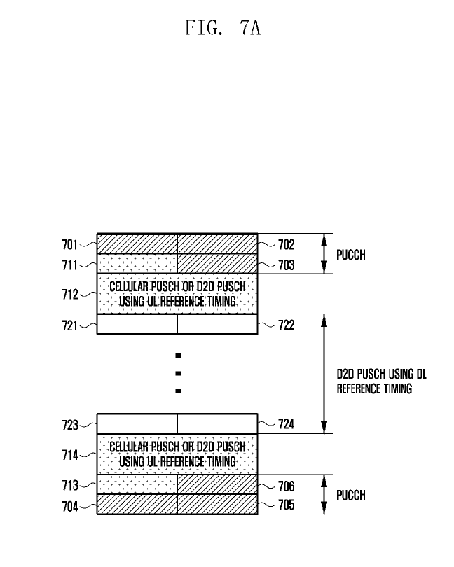

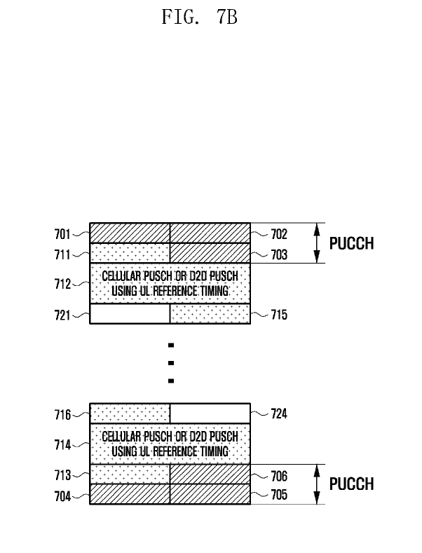

FIGS. 7A and 7B are diagrams illustrating some cases of using a guard RB for solving IBE and ICI issues according to another embodiment of the present disclosure.

FIG. 7A shows case in which frequency-axis resources (i.e., the number of RBs) for D2D PUSCH using downlink reference timing are unchanged (i.e., fixed) in all subframes. FIG. 7B shows case in which frequency-axis resources (i.e., the number of RBs) for D2D PUSCH using downlink reference timing are different in all subframes.

Meanwhile, in the TDM method applied to the above-discussed cases of FIGS. 6A to 6D, the guard RB was introduced to solve an IBE or ICI issue that arises at PUCCH by D2D PUSCH. On the contrary, cases of FIGS. 7A and 7B allocate D2D PUSCH (or cellular PUSCH) using uplink reference timing to RB adjacent to PUCCH. Namely, D2D PUSCH resources using uplink transmission reference timing are allocated to only a D2D transmitting device which may not affect the reception of PUCCH at the base station. For example, in the case of allocating D2D PUSCH resources using uplink transmission reference timing such that D2D devices near the base station, among RRC_Connected UEs, may perform transmission, an IBE or ICI issue may be obviated. Namely, devices located near the base station have insignificant difference between UL transmission timing (TX timing) and DL timing. Therefore, an ICI issue may be reduced.

Referring to FIGS. 7A and 7B again, RBs 701, 702, 703, 704, 705, and 706 of a PUCCH may be varied for each subframe. Therefore, D2D PUSCH resources 711, 712, 713, 714, 715, and 716 using uplink transmission reference timing for D2D transmitting devices located near the base station are allocated in the vicinity of RBs 701, 702, 703, 704, 705, and 706 of PUCCH, and then other D2D PUSCH resources 721, 722, 723, and 724 using downlink transmission reference timing for D2D transmitting devices located far from the base station are allocated therebetween.

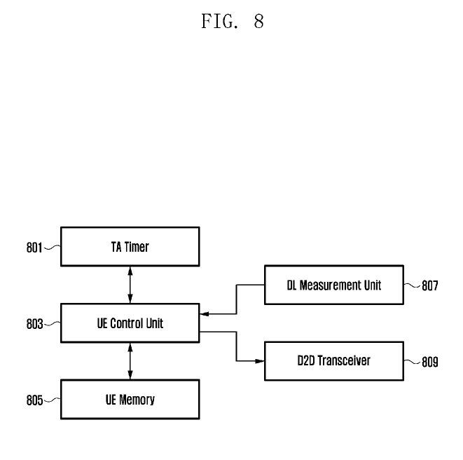

FIG. 8 is a block diagram illustrating a D2D transmitting device according to an embodiment of the present disclosure.

Referring to FIG. 8, the D2D transmitting device includes a TA timer 801, a UE control unit 803, a UE memory 805, a DL measurement unit 807, and a D2D transceiver unit 809. Although any other element may be further included in the D2D transmitting device, it is omitted for clarity of the disclosure.

The TA timer 801 may be set on the basis of control information received from the base station in an RRC_Connected mode with the base station. The TA timer 801 is operated for a predetermined time in the RRC_Connected mode with the base station. The TA timer 801 may initialize a TA timer value to a predetermined time value when information about a connected status is received before the expiration of the predetermined time or when a new base station is connected. Such setting and operating of the TA timer 801 may be controlled by the UE control unit 803.

The UE control unit 803 may control the overall operation required for the D2D transmitting device. Detailed description will be given with regard to a related flow diagram.

The UE memory 805 may include a region for storing control information, e.g., the first threshold value and the second threshold value received through SIB, received from the base station under the control of the UE control unit 803. Also, the UE memory 805 may further include a region for storing various kinds of information such as timing information for the D2D communication.

The DL measurement unit 807 may measure signal strength or received signal quality about a physical signal on DL from the base station under the control of the UE control unit 803. The DL measurement unit 807 may offer such measured information to the UE control unit 803. Additionally, the DL measurement unit 807 may obtain SIB information offered from the base station and then offer it to the UE control unit 803. Therefore, the DL measurement unit 807 may operate as a DL receiving unit.

The D2D transceiver unit 809 may configure data, required for the D2D communication, in the unit of a subframe under the control of the UE control unit 803 and then transmit the data at a time point controlled by the UE control unit 803. Also, in case of D2D reception, the D2D transceiver unit 809 may receive a D2D subframe through the reverse process of transmission.

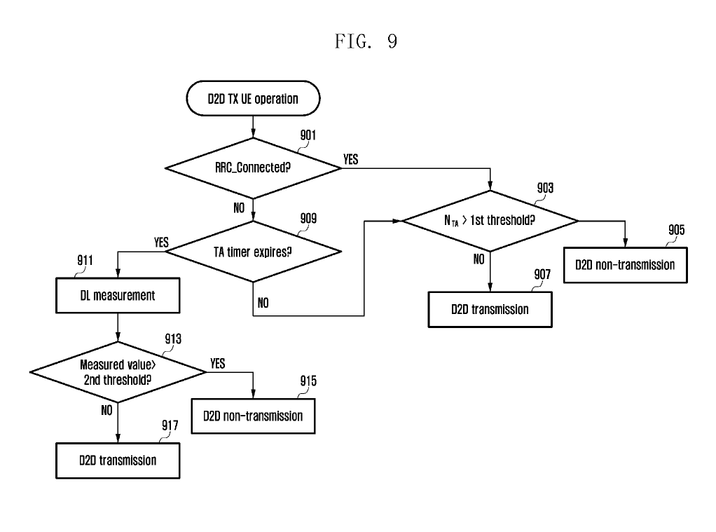

FIG. 9 is a flow diagram illustrating a transmission control operation for solving an ISI issue at a D2D transmitting device according to an embodiment of the present disclosure.

As discussed above, the UE control unit 803 may perform transmission at downlink reception timing in case of transmitting normal D2D subframe. However, the present disclosure restricts transmission of the last subframe of D2D transmission subframes in order to solve an ISI issue. Also, if necessary, some subframe other than the last subframe may be restricted similarly. FIG. 9 shows such a process.

At operation 901, in a case of desiring to transmit the last D2D subframe, the UE control unit 803 determines whether the device is in an RRC_Connected mode by using a status stored in the memory 805 or using information the UE control unit 803 has. In the case of being in the RRC_Connected mode, the UE control unit 803 performs operation 903.

At operation 903, the UE control unit 803 compares the first threshold value received through SIB with an N_{TA} value received from the base station. If the N_{TA} value is greater than the first threshold value, the UE control unit 803 abandons D2D transmission (D2D transmission is disallowed) at operation 905 since an ISI issue may arise at a WAN subframe. Otherwise, if the N_{TA} value is not greater than the first threshold value, the UE control unit 803 performs D2D transmission at operation 907.

Meanwhile, in the case of being not in the RRC_Connected mode at operation 901, the UE control unit 803 checks at operation 909 whether an expiration signal is received from the TA timer 801. If the TA timer expires, the UE control unit 803 performs operation 911. However, if the TA timer does not expire, the UE control unit 803 performs operation 903 since information received in the RRC_Connected mode is still valid.

Operation 911 is performed when the D2D transmitting device is not in the RRC_Connected mode and when the TA timer expires. Therefore, the UE control unit 803 performs downlink measurement by controlling the DL measurement unit 805. This downlink measurement is performed on the basis of physical signals such as PSS/SSS, CRS, DMRS, etc. transmitted through downlink, and may use various values such as RSRP, RSRQ, Received Signal Strength Indicator (RSSI), Signal to Interference and Noise Ratio (SINR), and the like. The present disclosure does not restrict a signal measurement.

After measurement of downlink at operation 911, the UE control unit 803 compares at operation 913 a downlink measured value with the second threshold value received through SIB. If the downlink measured value is greater than the second threshold value, the UE control unit 803 abandons D2D transmission of the last subframe (D2D transmission is disallowed) at operation 915 since an ISI issue may arise at a WAN subframe. Otherwise, if the downlink measured value is not greater than the second threshold value, the UE control unit 803 performs D2D transmission of the last subframe at operation 917.

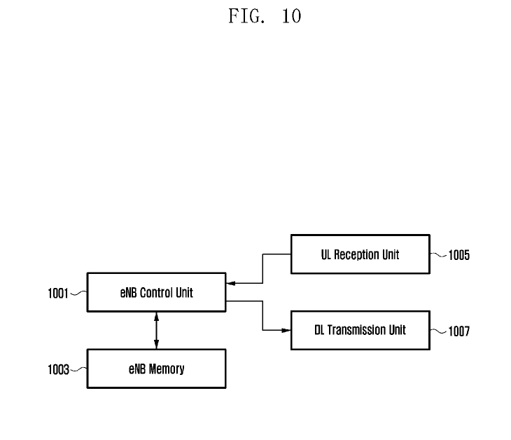

FIG. 10 is a block diagram illustrating a base station allowing a D2D communication according to an embodiment of the present disclosure.

Referring to FIG. 10, the base station may include an eNB control unit 1001, an eNB memory 1003, a UL reception unit 1005, and a DL transmission unit 1007. Although any other element may be further included in the base station, it is omitted for clarity of the disclosure.

The eNB control unit 1001 may control the overall operation of the base station, especially, perform various controls for supporting the D2D communication. Detailed description will be given with regard to a related flow diagram.

The eNB memory 1003 may include various memory regions for storing various kinds of control information required for the base station, for temporarily storing data created in a control process, and for buffering data received or to be transmitted.

The UL reception unit 1005 may receive signals from respective devices through uplink and also perform processing of the signals. The DL transmission unit 1007 may configure signals to be transmitted to respective devices through downlink and also perform processing of the signals.

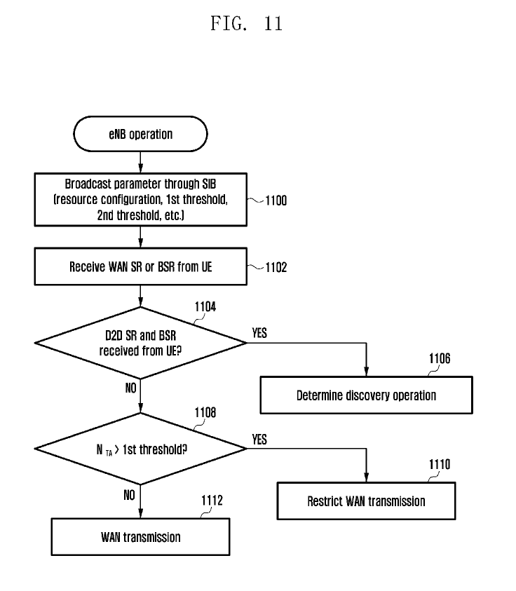

FIG. 11 is a flow diagram illustrating a control operation for solving an ISI issue at a base station according to an embodiment of the present disclosure.

At operation 1100, the eNB control unit 1001 transmits (i.e., broadcasts) discovery resource information (e.g., discovery period, Type 1/Type 2B reception resource pool, Type 1 discovery transmission pool, number of subframes, number of RBs, etc.), the first threshold value, and the second threshold value to all devices disposed in a cell thereof through SIB. Additionally, at operation 1102, the eNB control unit 1001 waits for reception of an SR or a BSR from devices operating in the cellular mode among D2D devices. Therefore, at operation 1104, the eNB control unit 1001 may check whether D2D SR and BSR are received from the device.

If D2D SR and BSR are received from the device, the eNB control unit 1101 may determine at operation 1106 whether to operate the device in the cellular mode (WAN) or in the D2D mode. Since this determination is a scheduling issue of the base station, a detailed description thereof will be omitted.

If the eNB control unit 1101 receives a cellular resource request from the D2D device but fails to receive a D2D resource request, the eNB control unit 1101 compares an N_{TA} value notified to the D2D device with the first threshold value at operation 1108. If the N_{TA} value is greater than the first threshold value, the eNB control unit 1101 may restrict cellular (WAN) transmission at operation 1110. Otherwise, if the N_{TA} value is not greater than the first threshold value, the eNB control unit 1101 performs scheduling for cellular transmission.

The above-described aspects of the present disclosure can be implemented in the form of computer-executable program commands stored in a non-transitory computer-readable storage medium. The non-transitory computer-readable storage medium is a data storage device capable of storing the data readable by a computer system. Examples of the non-transitory computer-readable storage medium include Read-Only Memory (ROM), Random-Access Memory (RAM), Compact Disc (CD) ROM, magnetic tape, floppy disc, optical data storage devices, and carrier waves (such as data transmission through Internet). The non-transitory computer-readable storage medium may be distributed to the computer systems connected through a network such that the non-transitory computer-readable codes are stored and executed in a distributed manner. The functional programs, codes, and code segments for implementing the present disclosure can be interpreted by the programmers skilled in the art.

The apparatus and method according to an embodiment of the present disclosure can be implemented by hardware, software, or a combination thereof Certain software can be stored in volatile or nonvolatile storage device such as ROM, memory such as RAM, memory chip, and integrated circuit, and storage media capable of recordable optically or magnetically or readable by machines (e.g., computer) such as CD, Digital Versatile Disc (DVD), magnetic disc, and magnetic tape. The method according to an embodiment of the present disclosure can be implemented by a computer or a mobile terminal including a controller and a memory, and the memory is a storage medium capable of storing and reading the program or programs including the instructions implementing the various embodiments of the present disclosure.

Thus the present disclosure includes the programs including the codes for implementing the apparatus and method specified in a claim of the present disclosure and a non-transitory machine-readable (computer-readable) storage media capable of storing the program and reading the program.

The apparatus according to an embodiment of the present disclosure may receive the program from a program providing device connected through a wired or wireless link and store the received program. The program providing device may include a program including instructions executing a pre-configured contents protection method, a memory for storing information necessary for the contents protection method, a communication unit for performing wired or wireless communication with a graphic processing device, and a controller for transmitting a request of the graphic processing device or the corresponding program automatically to the transceiver.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for allocating a resource at a base station of a wireless communication system which supports Device-to-Device (D2D) wireless communication, the method comprising:
creating system information including reception resource pool information to be used for the D2D wireless communication in a single radio frame, resource block information for the D2D wireless communication, and Physical Uplink Control Channel (PUCCH) information to be used for a cellular communication; and
broadcasting the created system information to devices for performing the cellular communication and the D2D wireless communication.

2. The method of claim 1, wherein the system information includes information about a first type resource using downlink transmission reference timing, information about a second type time and frequency resource using uplink transmission reference timing, and repeated period information about the first and second type resources.

3. The method of claim 2, wherein the system information further includes information for configuring a guard period by removing a predetermined number of symbols from a last subframe of the first type resource.

4. The method of claim 1, wherein the system information further includes information about a guard resource block between the resource block for the D2D wireless communication and the PUCCH used for the cellular communication.

5. The method of claim 4, wherein the guard resource block is allocated according to a number of resource blocks of the PUCCH.

6. A base station apparatus for allocating a resource in a wireless communication system which supports Device-to-Device (D2D) wireless communication, the apparatus comprising:
a control unit configured to create system information including reception resource pool information to be used for the D2D wireless communication in a single radio frame, resource block information for the D2D wireless communication, and Physical Uplink Control Channel (PUCCH) information to be used for a cellular communication; and
a downlink transmission unit configured to broadcast the created system information to devices for performing the cellular communication and the D2D wireless communication.

7. The apparatus of claim 6, wherein the system information includes information about a first type resource using downlink transmission reference timing, information about a second type time and frequency resource using uplink transmission reference timing, and repeated period information about the first and second type resources.

8. The apparatus of claim 7, wherein the system information further includes information for configuring a guard period by removing a predetermined number of symbols from a last subframe of the first type resource.

9. The apparatus of claim 6, wherein the system information further includes information about a guard resource block between the resource block for the D2D wireless communication and the PUCCH used for the cellular communication.

10. The apparatus of claim 9, wherein the guard resource block is allocated according to a number of resource blocks of the PUCCH.

11. A communication method of a device in a wireless communication system which supports Device-to-Device (D2D) wireless communication, the method comprising:
receiving system information including reception resource pool information to be used for the D2D wireless communication in a single radio frame, resource block information for the D2D wireless communication, and Physical Uplink Control Channel (PUCCH) information to be used for a cellular communication; and
performing the cellular communication or the D2D wireless communication, based on the received system information.

12. The method of claim 11, wherein the system information includes information about a first type resource using downlink transmission reference timing, information about a second type resource using uplink transmission reference timing, and repeated period information about the first and second type resources.

13. The method of claim 12, further comprising:
configuring a guard period by removing a predetermined number of symbols from a last subframe of the first type resource in a communication using the first type resource.

14. The method of claim 12, further comprising:
receiving resource allocation for D2D transmission based on the received system information in the D2D communication;
checking whether the device is in an RRC_Connected mode when transmitting data through allocated D2D transmission resource;
if the device is in the RRC_Connected mode, comparing a timing offset (N_{TA}) between the uplink transmission reference timing and the downlink transmission reference timing with a first threshold value contained in the system information; and
if the timing offset is greater than the first threshold value, disallowing D2D transmission.

15. The method of claim 14, further comprising:
if the timing offset is not greater than the first threshold value, performing the D2D transmission.

16. The method of claim 14, further comprising:
if the device is not in the RRC_Connected mode, checking whether a Timing Advance (TA) timer expires;
if the TA timer fails to expire and if the timing offset is greater than the first threshold value, disallowing D2D transmission; and
if the timing offset is not greater than the first threshold value, performing the D2D transmission.

17. The method of claim 16, further comprising:
if the TA timer expires, measuring physical signal strength of the downlink;
if the measured physical signal is greater than a second threshold value received as the system information, disallowing D2D transmission; and
if the measured physical signal is not greater than the second threshold value, performing the D2D transmission.

18. The method of claim 11, wherein the system information further includes information about a guard resource block between the resource block for the D2D wireless communication and the PUCCH used for the cellular communication.

19. The method of claim 18, wherein the guard resource block is allocated according to a number of resource blocks of the PUCCH.

20. A device apparatus for performing Device-to-Device (D2D) wireless communication in a wireless communication system which supports a cellular communication and the D2D communication, the apparatus comprising:
a downlink reception unit configured to receive system information from a base station;
a transmission unit configured to transmit data of the cellular communication or data of the D2D wireless communication; and
a control unit configured to obtain reception resource pool information to be used for the D2D wireless communication in a single radio frame, resource block information for the D2D wireless communication, and Physical Uplink Control Channel (PUCCH) information to be used for a cellular communication from the system information, to receive resource allocation based on the obtained information, and to control the transmission unit to perform the cellular communication or the D2D wireless communication through allocated resource.

21. The apparatus of claim 20, wherein the system information includes information about a first type resource using downlink transmission reference timing, information about a second type resource using uplink transmission reference timing, and repeated period information about the first and second type resources.

22. The apparatus of claim 21, wherein the control unit is further configured to configure a guard period by removing a predetermined number of symbols from a last subframe of the first type resource when the transmission unit transmits data by using the first type resource.

23. The apparatus of claim 21, wherein the control unit is further configured to check whether the device is in an RRC_Connected mode when transmitting data through the allocated resource for D2D transmission, to compare a timing offset (N_{TA}) between the uplink transmission reference timing and the downlink transmission reference timing with a first threshold value contained in the system information if the device is in the RRC_Connected mode, to control the transmission unit to disallow D2D transmission if the timing offset is greater than the first threshold value, and to control the transmission unit to perform the D2D transmission if the timing offset is not greater than the first threshold value.

24. The apparatus of claim 23, wherein the control unit is further configured to check whether a Timing Advance (TA) timer expires if the device is not in the RRC_Connected mode, to control the transmission unit to disallow D2D transmission if the TA timer fails to expire and if the timing offset is greater than the first threshold value, and to control the transmission unit to perform the D2D transmission if the timing offset is not greater than the first threshold value.

25. The apparatus of claim 24, wherein the control unit is further configured to measure physical signal strength of the downlink if the TA timer expires, to control the transmission unit to disallow D2D transmission if the measured physical signal is greater than a second threshold value received as the system information, and to control the transmission unit to perform the D2D transmission if the measured physical signal is not greater than the second threshold value.

26. The apparatus of claim 20, wherein the system information further includes information about a guard resource block between the resource block for the D2D wireless communication and the PUCCH used for the cellular communication.

27. The apparatus of claim 26, wherein the guard resource block is allocated according to a number of resource blocks of the PUCCH.
